(19) United States
(12) Patent Application Publication
(10) Pub. No.: US 2024/0095482 A1
(43) Pub. Date: Mar. 21, 2024

(54) System and Method for Generating Dynamic QR Code

(71) Applicant: David Williams, Dallas, TX (US)

(72) Inventor: David Williams, Dallas, TX (US)

(21) Appl. No.: 18/468,107

(22) Filed: Sep. 15, 2023

Related U.S. Application Data
(60) Provisional application No. 63/407,228, filed on Sep. 16, 2022.

(51) Int. Cl. G06K 19/06

(52) U.S. Cl. CPC G06K 19/06037

(57) ABSTRACT

A dynamic QR code system. The system generates a QR code that is associated with multiple URLs/links and can present different content upon each scan, enhancing user engagement and enabling real-time updates. By leveraging APIs, databases, and content management systems, the system automates content generation and updates, eliminating manual intervention. A business can order the QR code using a subscription and provides a list of URLs to be associated with the QR code. The list of URLs can be updated by renewing the subscription. Consumers can see new and dynamic data each time the dynamic QR code is scanned.

### CROSS-REFERENCE TO RELATED APPLICATION

The present application claims priority to, and the benefit of, U.S. Provisional Application No. 63/407,228, which was filed on Sep. 16, 2022, and is incorporated herein by reference in its entirety.

### FIELD OF THE INVENTION

The present invention generally relates to the field of QR codes. More specifically, the present invention relates to a novel QR code that can be associated with a plurality of URLs/Links. The QR code is generated by a QR code generation system upon request of a business or an individual and associates the QR code with multiple URLs. Upon being scanned each time, the QR code redirects to a different URL from the list of multiple URLs. The list of URLs can be updated, thereby providing consumers with up-to-date and dynamic content. Accordingly, the present disclosure makes specific reference thereto. Nonetheless, it is to be appreciated that aspects of the present invention are also equally applicable to other like applications, devices, and methods of manufacture.

### BACKGROUND

By way of background, scanning of codes such as barcodes, Quick Response (QR) codes, and other machine-readable codes are widely used in different industries for a plurality of reasons including presentation of information, driving engagement and more. QR codes can store various types of information, including text, URLs, contact details, Wi-Fi network credentials, and more. When scanned with a compatible device, the QR code can quickly and conveniently transfer the encoded data to the user's device.

Conventional QR codes are associated with a URL/link which is opened upon scanning of the QR code by an imaging device such as a smartphone camera. However, in conventional QR codes, the content displayed by a QR code remains fixed, and any updates or changes require the manual intervention of the administrator or owner of the code. Many times, businesses want to display dynamic content to their consumers, however, conventional static QR codes pose challenges in scenarios where real-time or dynamic content display is essential. Businesses require an improved QR code system that overcomes the limitations of static codes and enables for dynamic content display.

Therefore, there exists a long felt need in the art for a dynamic QR code that can be associated with multiple URLs/links. There is also a long felt need in the art for a QR code system that displays new content each time the QR code is scanned. Additionally, there is a long felt need in the art for an improved scannable code that enables businesses to deliver personalized and contextually relevant information to users. Moreover, there is a long felt need in the art for a QR code that helps businesses in enhancing engagement and user experience by providing new information on each scanning of the code. Further, there is a long felt need in the art for an improved QR code that alleviates the manual burden on administrators or owners of QR codes, eliminating the need for manual updates in the information associated with the QR code. Furthermore, there is a long felt need in the art for an improved QR code that can be associated or encoded with multiple URLs/links. Finally, there is a long felt need in the art for a dynamic QR code that presents dynamic information to users upon being scanned and helps businesses in providing targeted marketing campaigns and real-time updates.

The subject matter disclosed and claimed herein, in one embodiment thereof, comprises a dynamic QR code. The dynamic QR code is associated with a plurality of URLs, the plurality of URLs can be two or more and is provided by a user using a website, the dynamic QR code is configured to be scanned by an imaging device and redirects to a first URL from the plurality of URLs upon being scanned by the imaging device. The dynamic QR code redirects to a second URL from the plurality of URLs upon being scanned again by the imaging device wherein the first URL and the second URL are not the same and are sequential in the plurality of the URLs. The QR code redirects to each URL in the plurality of URLs sequentially upon being scanned and therefore enables businesses to provide dynamic information for driving engagement.

In this manner, the dynamic QR code of the present invention accomplishes all of the forgoing objectives and provides businesses with an improved QR code that can be associated with multiple URLs/links. Each time upon being scanned, the QR code presents a new URL from the list of associated URLs to display new information to a user, thus, helping businesses in driving engagement and providing targeted information. The list of associated URLs can be updated, thereby keeping the QR code dynamic with up-to-date information.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a dynamic QR code. The dynamic QR code is associated with a plurality of URLs wherein the dynamic QR code redirects to a first URL from the plurality of URLs upon being scanned by an imaging device, the dynamic QR code redirects to a second URL from the plurality of URLs upon being scanned again by the imaging device wherein the first URL and the second URL are not the same and are sequential in the plurality of the URLs.

In a further embodiment, a method for generating a dynamic QR code is described. The method comprising the steps of receiving a request from a user for purchasing a dynamic code, wherein the request is submitted through a website or a mobile application provided by a dynamic QR code generation system, receiving contact information, including an email ID, from the user to which the dynamic QR code is digitally delivered by the system, receiving a plurality of URLs from the user, wherein all the provided URLs are to be associated with the dynamic QR code, generating the dynamic QR code based on a successful payment by the user, wherein the dynamic QR code is designed to display a different URL from the list of URLs upon being scanned each time.

In yet another embodiment, the dynamic QR code is activated and subscribed for a predetermined duration, such as one month, upon successful payment by the user, wherein the subscription can be renewed for maintenance of the QR code.

In a further embodiment, a system for generating a QR code associated with a plurality of URLs is disclosed. The system comprising a website or an application, a server system comprising a server, a database, an object storage, a mailing server, and a rule engine, wherein the server system is communicatively coupled to the website or application, wherein the server receives a list of URLs to be associated with the QR code, and wherein the server system associates the list of URLs with the QR code, wherein the QR code upon being scanned each time displays a different URL from the list of URLs.

In a further embodiment, a new list of URLs can be provided by a user wherein the new list of URLs can be associated with the QR code for updating the QR code and thus allowing businesses to display up-to-date and dynamic information to consumers for driving engagement and sales.

In yet another embodiment, the QR code is in the form of a grid and is delivered to an email address provided by the user.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a flowchart depicting a process of ordering a dynamic QR code using the dynamic QR code generation system of the present invention in accordance with the disclosed architecture;

FIG. 2 illustrates a flow chart depicting a process of updating the dynamic QR code generated for a user/business to include new webpages/information in accordance with the disclosed architecture;

FIG. 3 illustrates a flow chart depicting use of the revolving content QR code used in the present invention, according to an embodiment of the present invention;

FIG. 4 illustrates architectural components used in the dynamic QR code generation system of the present invention in accordance with the disclosed architecture;

FIG. 5 illustrates an architectural diagram showing a process flow during generation of a dynamic QR code for a business using the system in accordance with the disclosed architecture;

FIG. 6A provides a workflow for order submission by a customer for QR code image generation;

FIG. 6B illustrates the order fulfillment workflow of the dynamic QR code generation system of the present invention;

FIG. 6C illustrates the QR scanning workflow of scanning a dynamic QR code by a user as per an embodiment of the present invention;

FIG. 6D illustrates the QR Subscription workflow used for management of subscriptions of the businesses in accordance with the disclosed architecture; and

FIG. 6E depicts a cancellation workflow of the subscription of a business, which encompasses order submissions, subscription renewals, and automatic order generation management.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a dynamic QR code that can be associated with multiple URLs/links. There is also a long felt need in the art for a QR code system that displays new content each time the QR code is scanned. Additionally, there is a long felt need in the art for an improved scannable code that enables businesses to deliver personalized and contextually relevant information to users. Moreover, there is a long felt need in the art for a QR code that helps businesses in enhancing engagement and user experience by providing new information on each scanning of the code. Further, there is a long felt need in the art for an improved QR code that alleviates the manual burden on administrators or owners of QR codes, eliminating the need for manual updates in the information associated with the QR code. Furthermore, there is a long felt need in the art for an improved QR code that can be associated or encoded with multiple URLs/links. Finally, there is a long felt need in the art for a dynamic QR code that presents dynamic information to users upon being scanned and helps businesses in providing targeted marketing campaigns and real-time updates.

The present invention, in one exemplary embodiment, is a computer-implemented system for generating a revolving QR code associated with a plurality of URLs. The system comprising a website or an application, a server system comprising a server, a database, an object storage, and a mailing server, wherein the server system is communicatively coupled to the website or application, wherein the server receives a list of URLs to be associated with the QR code, and wherein the server system associates the list of URLs with the QR code, wherein the QR code upon being scanned each time displays a different URL from the list of URLs. The database stores the list of URLs and the object storage stores the QR code which is emailed to consumers using the mailing server.

In terms of computing environments, embodiments of the invention can be performed in client-server environments, whether network or local environments, or in any other suitable environment. Suitable operating environments for at least some embodiments of the invention include cloud computing environments where one or more of a client, server, or other machine may reside and operate in a cloud environment.

As used herein, the term ‘module’ or ‘component’ can refer to software objects or routines that execute on the computing system. The different components, modules, engines, and services described herein may be implemented as objects or processes that execute on the computing system, for example, as separate threads.

The embodiments disclosed herein may include the use of a special purpose or general-purpose computer including various computer hardware or software modules, as discussed in greater detail below.

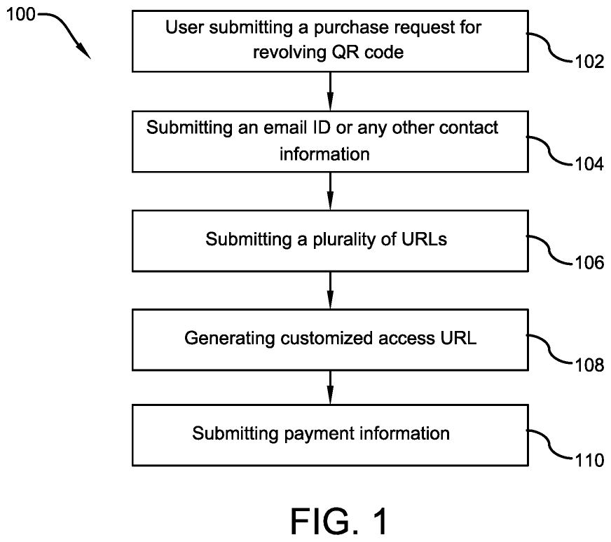

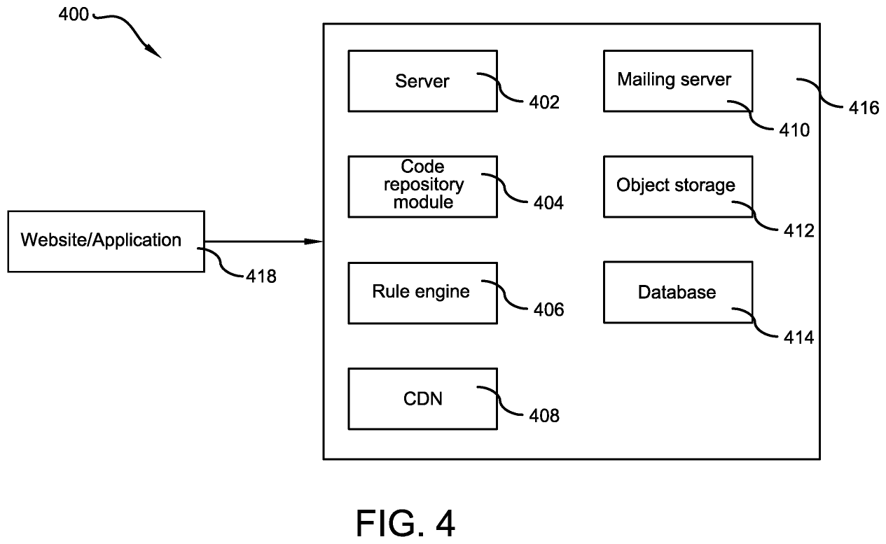

Referring initially to the drawings, FIG. 1 illustrates a flowchart 100 depicting a process of ordering a dynamic QR code using the dynamic QR code generation system of the present invention in accordance with the disclosed architecture. The dynamic QR code generated by the dynamic QR code generation system 400 shown in FIG. 4 is associated with a plurality of webpages/information wherein the QR code upon being scanned, displays a new webpage from the plurality of associated webpages/information, and thus providing new and relevant information each time the QR code is scanned.

For ordering the dynamic QR code, initially, a user such as a business or an individual submits a request for purchasing Constantly revolving QR code or dynamic code (Step 102). The request can be submitted using a website (such as offered through SquareSpace) or a mobile application offered by the dynamic QR code generation system. Upon requesting the QR code, the user then submits an email ID or any other contact information to which the dynamic QR code is digitally delivered by the system (Step 104). Thereafter, a plurality of URLs is provided by the user, wherein all the provided URLs are to be associated with the dynamic QR code by the system 400 during generation of the QR code (Step 106). Then, a personalized URL is generated and submitted by the user, wherein the personalized URL can directly display the ordered dynamic QR code (Step 108). The personalized URL can be shared with different users for allowing them to directly scan the dynamic QR code displayed by the personalized URL.

After submitting the details in the above steps, payment details such as a credit card, debit card, wallet, or any other payment method are chosen and the user purchases the dynamic QR code (Step 110). It should be noted that the dynamic QR code is activated and subscribed for a predetermined duration such as one month upon successful payment by the user as described in Step 110. The dynamic QR code generated by the system can be used by businesses for improving engagement by displaying multiple webpages and information to users upon scanning of the QR code.

The subscription of a business can be renewed by paying the registration fee again by the business and based on successful renewal, the QR code remains activated for being used and scanned by users.

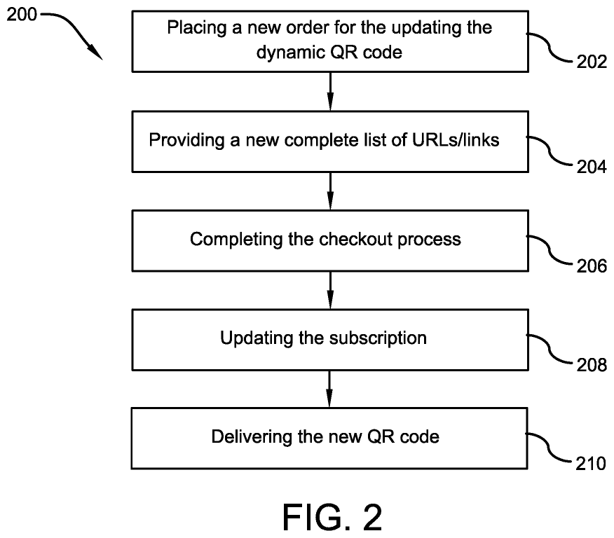

FIG. 2 illustrates a flow chart 200 depicting a process of updating the dynamic QR code generated for a user to include new webpages/information in accordance with the disclosed architecture. For updating the webpages/information associated with the dynamic QR code, the user places a new order for the dynamic QR code as described in FIG. 1 (Step 202). The contact information such as the email ID remains the same (same as of the one used in the earlier order). Then, the user provides a new complete list of URLs/links to be associated with the dynamic QR code generated earlier for the user (Step 204). It should be noted that some of the URLs/links can be same as of the earlier links shared by the user.

Then, the user completes the checkout process by paying a subscription fee(s) (Step 206) and then, the system updates the existing dynamic QR code for the user with the new list of URLs/links (Step 208). Finally, the user can deactivate the original subscription and receive the new QR code associated with the new URLs/links (Step 210).

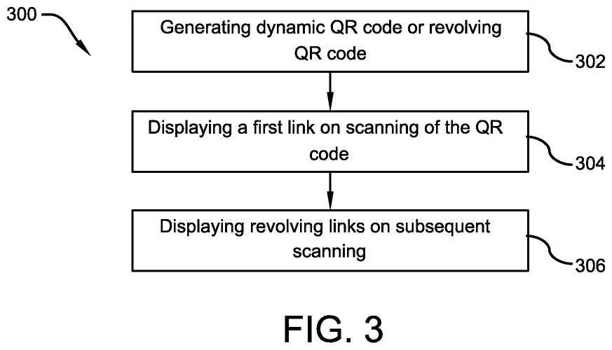

FIG. 3 illustrates a flow chart 300 depicting use of the revolving content QR code used in the present invention, according to an embodiment of the present invention. Initially, the dynamic QR code or revolving QR code generated by the system as described in FIGS. 1 and 2 is scanned by a user (Step 302). The scanning of the QR code can be performed using a digital imaging camera such as a rear camera or a front camera of a smartphone and the like. Upon the first scanning of the QR code, a URL/link from the list of the URLs/links associated with the QR code is opened in a browser, enabling the user to view the information included in the webpage displayed by the URL/link (Step 304). Then, upon subsequent scanning of the QR code by the user, the next URL/link from the list of the URLs/links associated with the QR code is opened (Step 306) to provide dynamic information to the user. Each time the QR code is scanned by the user, the QR code revolves to the next URL provided in the list associated with the QR code.

The revolving content QR codes generated by the revolving content QR code generating system of the present invention associate each QR code with a plurality of URLs/links. Further, the revolving content QR codes can be printed on clothing and on any surface and further can be embodied as stickers.

FIG. 4 illustrates architectural components used in the dynamic QR code generation system of the present invention in accordance with the disclosed architecture. The revolving QR system 400 includes several key components that synergistically work together to provide a seamless and efficient system for businesses/users to purchase revolving QR codes and enabling users/consumers to scan them for dynamic information. The scope of the invention is not limited to this example implementation and any serverless implementation can be used for working of the invention.

The QR code system 400 includes a server system 416 that includes a server 402 which can be a cloud server or alternatively can be a physical server. In the preferred embodiment, the server 402 is in the form of a serverless compute service such as AWS Lambda offered by Amazon Web Services (AWS). The server 402 provides the underlying infrastructure and automatically scales the code (in a supported programming language, such as Node.js) in response to incoming requests or events from users. The server 402 is configured to create different application programming interfaces (APIs) from the code and provide a rule engine for offering different rules such as rule-based access for accessing the system 400.

The user code for providing functionality offered by the system 400 is stored in a code repository module 404 wherein the user code is updated to include additional functionality and API integrated server (Lambda) function uses the user code.

The rule engine 406 is configured to provide authorizations and permissions for the users and maintain subscriptions of the users. The rule engine 406 provides association of the URLs/Links with the revolving QR codes and the rule engine 406 is a serverless policy implemented on the serverless computing server 402.

For delivering the QR codes to subscribed users, a content delivery network (CDN) 408 is included in the system 400. The QR code images are efficiently delivered to users through the CDN such as AWS CloudFront. The CDN 408 optimizes the delivery process of the QR codes by leveraging the global network of edge locations. This results in fast and reliable delivery of QR code images, enhancing the overall user experience.

A mailing server 410 is used for emailing the QR code images to subscribed users. The mailing server 410 is also used for automatically creating personalized emails for the subscribed users.

An object storage 412 such as AWS S3 Storage is included and serves as a secure and reliable storage solution for the generated QR code images. The system 400 preferably stores the QR code images in the S3 storage ensuring their accessibility and integrity. In different embodiments of the present invention, any type of object storage, block storage, file storage and more can be used for storing the QR code images.

A database 414 is used for securely storing the order details and other information such as email address, payment details of subscribers of the system 400. The database 414 can be any type of SQL database, NoSQL database, computing database and in the preferred embodiment, can be a NoSQL database such as MongoDB. The database 414 stores the order details in flexible, JSON-like documents called BSON (Binary JSON). The database 414 is designed for handling large amounts of unstructured or semi-structured data.

The website or application 418 can be made on any platform such as SquareSpace and any conventional technology can be used for allowing users to access the system 400 for generating and accessing revolving QR codes.

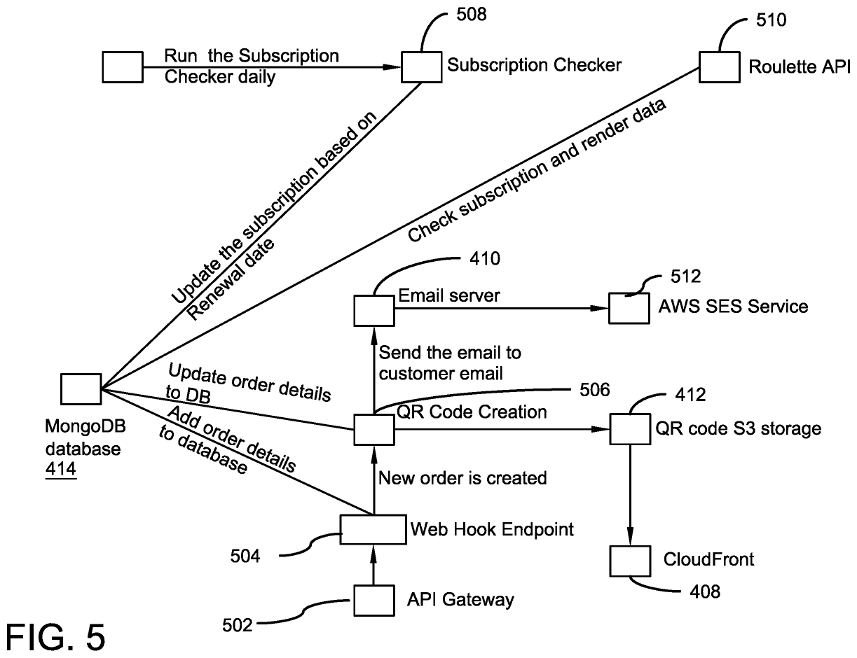

FIG. 5 illustrates an architectural diagram showing process flow during generation of a dynamic QR code for a business using the system in accordance with the disclosed architecture. Using an API gateway 502 that is configured to provide an interface for a plurality of APIs (described later in the disclosure), QR code order processing data is received by the system. A webhook endpoint API 504 is coupled to the API gateway 502 wherein the webhook endpoint 504 enables real-time communication allowing for efficient data exchange and integration between a requesting user and the QR code generation system. The webhook endpoint 504 can be associated with a webhook endpoint URL which receives QR code order data from a user via the API gateway 502.

A QR code creation module 506 is configured to generate a new revolving QR code as described in FIGS. 1 and 2 upon receiving information from the webhook endpoint 504 and the URLs details from the MongoDB 414. The MongoDB 414 stores order details and real-time updates regarding the orders of the customers ordering QR codes using the system. The mailing server 410 receives the revolving QR codes from the QR code creation module 506 and emails the QR code images to subscribed users using an emailing service 512 such as AWS Simple emailing service (SES).

The QR codes generated by the QR code creation module 506 are also stored in the object storage 412 for tracking and back up processes. The distribution of the QR codes also use a CDN 408 as described in FIG. 4. A subscription checker API 508 of the system is configured to check subscriptions of a business. In the preferred embodiment, a business or a user is provided subscription for a limited time such as one month, two months or the like wherein the QR code generated for the business remains active. The subscription can be renewed as described in FIG. 1 and the subscription checker API 508 updates the renewal information of a business in the database 414. In the preferred embodiment, the subscription checker API 508 checks the subscriptions of businesses on a daily basis and may send a reminder email using the emailing service 512 for the renewal date of the subscription. A Roulette API 510 is used for checking the subscription of business before rendering the associated data of the QR code to the users.

The system of the present invention uses a plurality of APIs for processing of orders and generation of QR codes. The table below “Table 1” lists different APIs used by the system.

TABLE 1

| API | Overview |
|---|---|
| Webhook endpoint | An order on website triggers a web-hook that calls |
| | the webhook endpoint. The endpoint creates an |
| | access token to communicate with other APIs. |
| qrCreationsS3upload | This API creates QR codes based on unique |
| | order IDs and stores in object storage. |
| tokenCreator | Creates an access token to communicate with |
| | ordering APIs. |
| sendEmail | An API for sending emails to customers. |
| Qrcode-update-order | API to update order status in the database. |
| Roulette-api | Provides the list of URLs one-by-one on scanning |
| | of the QR code by a user. |
| Subscription-checker | Checks the renewal and makes the subscription |
| | active/inactive. |

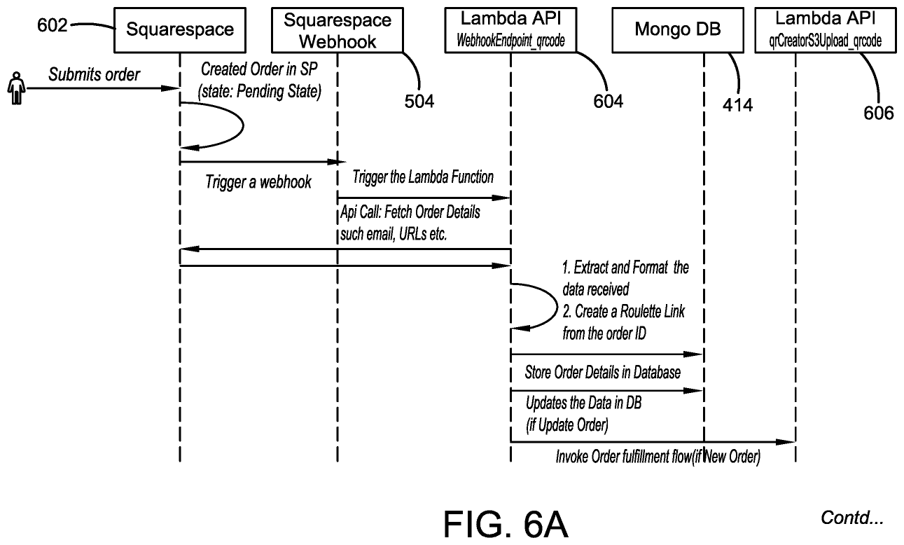

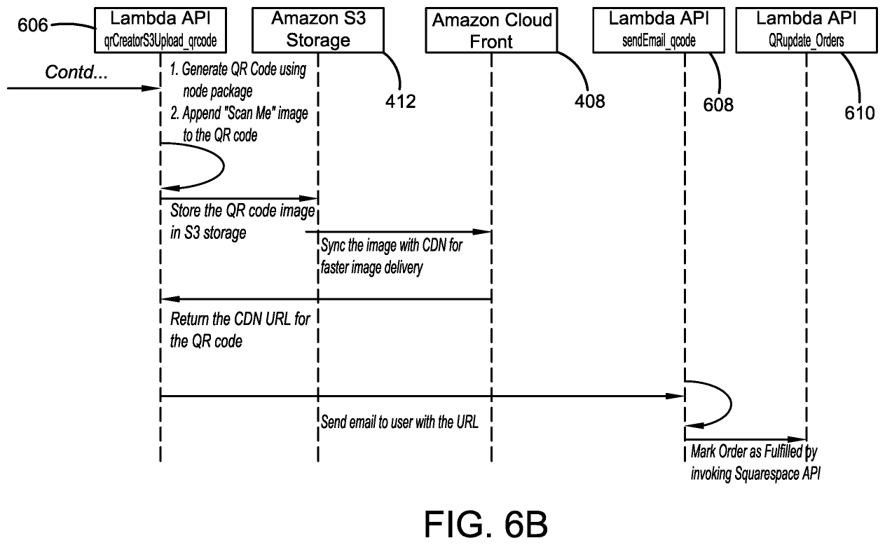

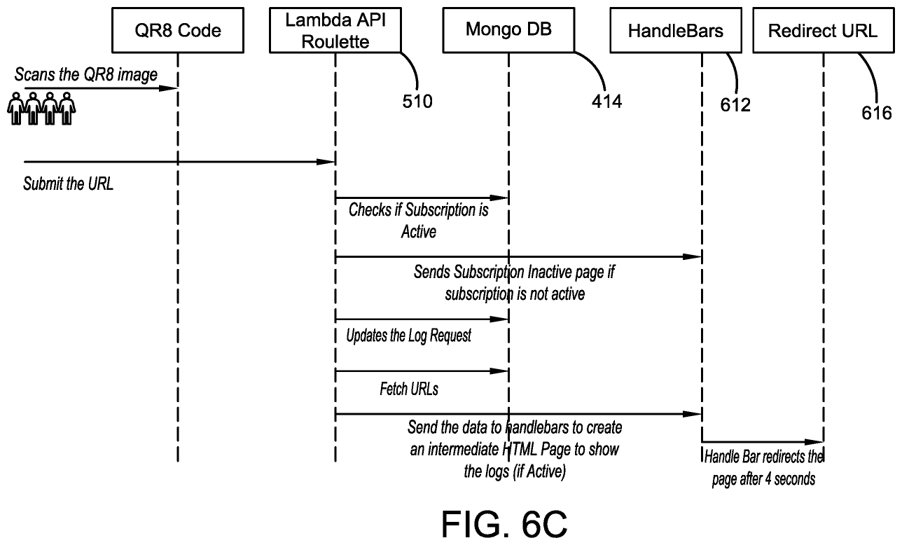

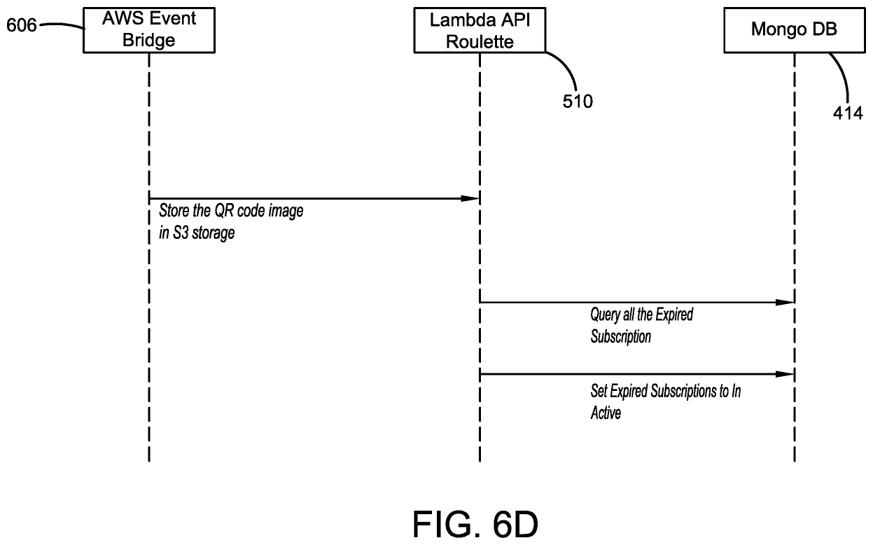

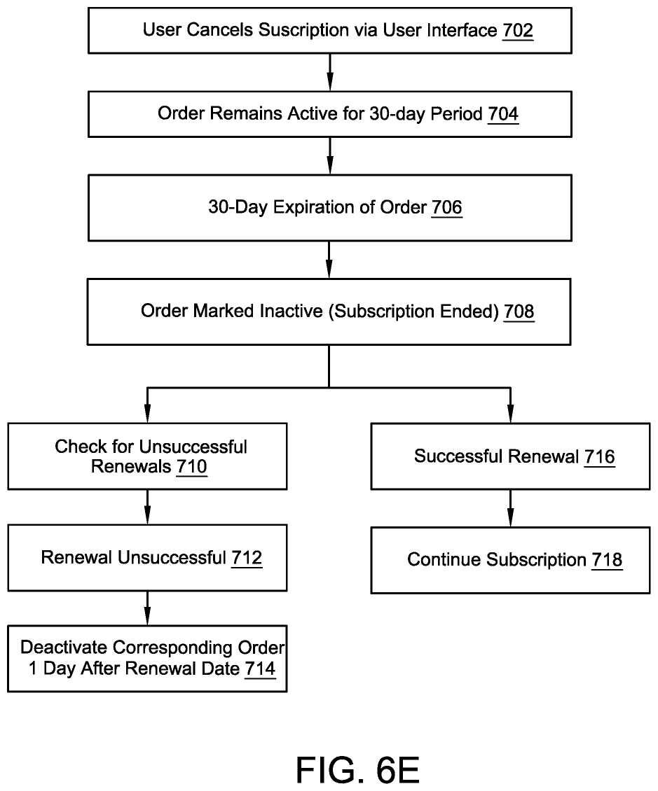

With reference now to FIG. 6A, details are provided for order submission by a customer for QR code image generation. In general, FIG. 6A discloses the order generation process in an Amazon Lambda implementation, although the QR code generation system and the process can be implemented over any object store and serverless architecture. The user initiates an order submission process by providing the necessary details through an application or website. In the present implementation, the order is created in SquareSpace 602 (the system uses SquareSpace as an example for creating website, user interface, and more) with its state marked as “pending”. SquareSpace 602 detects the new order and triggers the webhook 504. This webhook 504 is configured to invoke a Lambda function 604 “WebhookEndpoint_qrcode”.

The Lambda function receives payload containing information about the order. The WebhookEndpoint_qrcode Lambda function extracts the relevant data from the webhook 504 payload and formats it for further processing. This data can include details such as the customer's email address, URLs associated with the order, and any other pertinent information.

Using the extracted order data, the WebhookEndpoint_qrcode Lambda function generates a Roulette Link. This link is created based on the unique identifier (ID) of the order and is used to deliver dynamic content associated with the order. Moreover, the WebhookEndpoint_qrcode Lambda function stores the order details, including the customer's email, URLs, and the generated Roulette Link, in the database 414. Further, the updates in the order, such as changes in the order status or additional information are updated in in the database 414.

Furthermore, if the order is a new submission, the Lambda function triggers the order fulfillment flow (as shown in FIG. 6B). This flow ensures that the necessary steps are taken to process and fulfill the order, such as generating QR codes and managing inventory. As part of the order fulfillment flow, another Lambda function 606 “qrCreatorS3Upload_qrcode” is invoked. This function handles the creation and storage of QR codes associated with the order. The QR codes are generated using the QR code creator based on the unique identifiers of the orders and are uploaded to an appropriate storage location, such as an S3 storage bucket 412.

FIG. 6B illustrates the order fulfillment workflow of the dynamic QR code generation system of the present invention. The Lambda API 606 “qrCreatorS3Upload_qrcode” generates the QR code using a node package. The API 606 creates the QR code based on the unique identifier of the order. Additionally, the API 606 appends a “Scan Me” image to the QR code, making the QR code more user-friendly.

The generated QR code image is stored in Amazon S3 storage 412. The image is synchronized with the CDN 408 for faster delivery to users. The workflow then moves to CDN 408, which returns a CDN URL for the QR code image.

A Lambda API 608 “sendEmail_qrcode” is then invoked. This API 608 sends an email to the user, containing the URL of the QR code. The user can then access the QR code by clicking the URL provided in the email.

The Lambda API 608 “sendEmail_qrcode” marks the order as fulfilled by invoking the API 610 “QrupdateOrders”. By making this API call, the order status is updated in the system to reflect the fulfillment of the order. The order fulfillment workflow ensures that the QR code is generated, stored securely in Amazon S3 storage 412, and delivered to users through a CDN 408. The email notification with the QR code URL provides users with a convenient way to access their order information.

In FIG. 6C, the QR scanning workflow of scanning a dynamic QR code by a user is depicted. This workflow involves the scanning of a QR code generated for a business by a user. The workflow begins when a user (such as customer of a business) scans a QR code using a QR scanning application (such as a camera) on their device. The QR code contains encoded information such as URLs/Links. The scanned QR code triggers the Roulette Lambda API 510. This API 510 receives the URL associated with the QR code as an input for further processing.

The Roulette Lambda API 510 is configured to perform several tasks based on the scanned URL. Firstly, the API 510 checks if the subscription of the business whose QR code is scanned by the user is active by querying the database 414 where subscription details are stored. If the subscription is inactive, the workflow proceeds to display a subscription inactive page using any conventional technology such as using Handlebars or other templating engine.

Regardless of the subscription status, the Roulette Lambda API 510 updates the log request in the database 414. This log request captures relevant information about the scanned QR code, such as the timestamp and any associated metadata.

Further, if the user's subscription is active, the workflow continues by fetching the relevant URLs (from the list of URLs associated with the QR code) from the database 414. These URLs represent the dynamic or revolving content be displayed to the user as described in FIGS. 1-3.

The fetched URLs are passed to Handlebars 612, which dynamically generates an intermediate HTML page using a redirect URL 616. This page is used to present the logs and associated URLs to the user, providing a detailed overview of the scanned QR code's information. After a short duration, for example, of 4 seconds, Handlebars redirects the user to the generated HTML page. This ensures a smooth and seamless user experience, allowing them to view the scanned QR code's data and associated URLs. Moreover, the QR scanning workflow enables users to scan QR codes and receive appropriate responses based on their subscription status.

FIG. 6D illustrates the QR Subscription workflow used for management of subscriptions of the businesses in accordance with the disclosed architecture. The system triggers the workflow at a specified time on a daily basis, for example at 10 AM US time, by using a checking module 614 such as AWS Event Bridge. The subscription checking process can be triggered at any user specified time not limiting to only 10 AM.

The Roulette API 510 interacts with the database 414 to query all the expired subscriptions. The Roulette API 510 retrieves subscription information that has reached its expiration date and based on the retrieved data, the Roulette API 510 updates the status of the expired subscriptions to “inactive.” This step ensures that users with expired subscriptions are no longer able to access the full features of the application.

By utilizing AWS Event Bridge 614 and the Roulette Lambda API 510 in conjunction with the database 414, the QR Subscription workflow automates the process of checking and updating subscription statuses. This helps in maintaining an accurate and up-to-date record of active and inactive subscriptions, ensuring that users with expired subscriptions are appropriately managed within the application.

FIG. 6E depicts a cancellation workflow of the subscription of a business, which encompasses order submissions, subscription renewals, and automatic order generation management. The cancellation flow is designed to handle these scenarios seamlessly, ensuring efficient subscription management. When a user submits an order, a Subscription ID for the subscription is generated in the system, serving as a unique identifier for the user's subscription. Subsequent renewal result in the generation of a new Order ID tagged with the earlier generated Subscription ID. This approach ensures accurate association of each renewal with the corresponding subscription. Furthermore, the system marks the renewal date of each Order ID as 30 days from its creation, facilitating tracking of renewal periods and maintaining active subscriptions for the designated timeframe.

The cancellation workflow is triggered under two specific scenarios: manual cancellation by the user through the application's user interface (UI) and unsuccessful subscription renewals. In the case of manual cancellation, when a user chooses to cancel their subscription manually via the application's UI (Step 702), the cancellation workflow is initiated promptly. The associated order remains active until the end of the 30-day window (Step 704), allowing the user to continue accessing the subscription benefits until the expiration of this period (Step 706). Subsequently, the subscription is marked as inactive, terminating the user's access to the subscription benefits (Step 708).

In the scenario of unsuccessful renewals (Step 710), the QR system takes appropriate action to address the situation. A daily job runs within the application, monitoring past-dated orders that have not been renewed as of the previous day, with a 1-day buffer (Step 712). If a renewal is not successful, the system deactivates the corresponding order 1 day after the renewal date (Step 714). This proactive measure ensures that the subscription is promptly marked as inactive, preventing further access to benefits or services associated with that subscription. In case of successful renewal (Step 716), the subscription is renewed (Step 718)

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “dynamic QR code generation system”, “QR code system”, “revolving QR code generation system”, and “system” are interchangeable and refer to the dynamic QR code generation system 100 of the present invention.

Notwithstanding the forgoing, the dynamic QR code generation system 100 of the present invention can be of any suitable configuration as is known in the art without affecting the overall concept of the invention, provided that it accomplishes the above-stated objectives. One of ordinary skill in the art will appreciate that the configuration and specification of the components of the dynamic QR code generation system 100 as shown in FIGS. 1-6 is for illustrative purposes only, and that many other configurations of the dynamic QR code generation system 100 are well within the scope of the present disclosure.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A dynamic QR code generating system comprising:
a dynamic QR code generated by a dynamic QR code generating system having a plurality of webpages associated therewith;
wherein said dynamic QR code having successive webpages associated with said dynamic QR code including successive content information in response to successive scans of said dynamic QR code by a first user;
wherein said dynamic QR code in response to a first scan displays a first content page and in response to a subsequent second scan displays a second content page; and
further wherein said second content page is different from said first content page.

2. The dynamic QR code generating system of claim 1, wherein at least one of said first content page and said second content page having a URL.

3. The dynamic QR code generating system of claim 2, wherein upon said first scan of said dynamic QR code a URL link from a list of URL links associated with said dynamic QR code is opened in a browser.

4. The dynamic QR code generating system of claim 3, wherein said first user views said first content page associated with said URL link.

5. The dynamic QR code generating system of claim 4, wherein said first user views said second content page associated with another URL link.

6. The dynamic QR code generating system of claim 3, wherein each time said dynamic QR code is scanned by said first user, said dynamic QR code revolves to another URL link from said list of URL links.

7. A method for generating and using a dynamic QR code, the method comprising the steps of:
ordering a dynamic QR code from a dynamic QR code generation system;
purchasing said dynamic QR code;
submitting an email ID of a user;
submitting a plurality of URLs of said user;
associating said plurality of URLs with said dynamic QR code; and
generating an access URL for said dynamic QR code.

8. The method for generating the dynamic QR code of claim 7, wherein said access URL is a personalized URL.

9. The method for generating the dynamic QR code of claim 8, further comprising the step of sharing with different users said personalized URL.

10. The method for generating the dynamic QR code of claim 9, further comprising the step of scanning said dynamic QR code displayed by said personalized URL.

11. The method for generating the dynamic QR code of claim 10, further comprising the step of submitting payment for said dynamic QR code.

12. The method for generating the dynamic QR code of claim 11, further comprising the step of activating for a predetermined duration said dynamic QR code.

13. The method for generating the dynamic QR code of claim 10, further comprising the step of displaying multiple webpages and information to the users upon scanning of said dynamic QR code.

14. The method for generating the dynamic QR code of claim 7, further comprising the step of updating said dynamic QR code generated for the user to include submitting another plurality of URLs of said user.

15. The method for generating the dynamic QR code of claim 14, further comprising the step of submitting a subscription payment for said dynamic QR code.

16. A method for generating and using a dynamic QR code, the method comprising the steps of:
ordering a dynamic QR code from a dynamic QR code generation system;
submitting an email ID of a user;
submitting a revolving plurality of URLs of said user;
associating said revolving plurality of URLs with said dynamic QR code;
generating an access URL for said dynamic QR code; and
scanning said dynamic QR code with a digital imaging camera.

17. The method for generating and using a dynamic QR code of claim 16, wherein upon a first scan of said dynamic QR code a first URL link from said revolving plurality of URLs associated with said dynamic QR code is opened in a browser.

18. The method for generating and using a dynamic QR code of claim 17, wherein a first user views a first content page associated with said first URL link.

19. The method for generating and using a dynamic QR code of claim 17, wherein upon a second scan of said dynamic QR code a second URL link from said revolving plurality of URLs associated with said dynamic QR code is opened in the browser.

20. The method for generating and using a dynamic QR code of claim 19, wherein each time said dynamic QR code is scanned by said first user, said dynamic QR code revolves to another URL link of said revolving plurality of URLs.
